(19) United States
(12) Patent Application Publication
(10) Pub. No.: US 2007/0009782 A1
(43) Pub. Date: Jan. 11, 2007

(54) Flow path structure, production method thereof and fuel cell system

(75) Inventors: Fuminobu Tezuka, Yokohama-shi (JP); Yuusuke Sato, Bunkyo-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/180,707

(22) Filed: Jul. 14, 2005

(30) Foreign Application Priority Data
Jul. 15, 2004 (JP) 2004-208130

(51) Int. Cl. H01M 8/02; B05D 5/12

(52) U.S. Cl. 429/39; 427/115

(57) ABSTRACT

A flow path structure is provided with: a first flow path member having a plurality of through grooves, the through grooves being disposed adjacent to each other; a second flow path member having a fitting portion, in the fitting portion the first flow path member being fitted; a third flow path member covering the fitting portion so as to be sealed, the third flow path member being provided on the second flow path member; an inflow port to receive a fluid; an outflow port to exhaust an exhaust fluid; and a flow path formed in the fitting portion along the first flow path member, the flow path linking the inflow port and the outflow port and running through the through grooves.

### CROSS-REFERENCE TO RELATED APPLICATIONS

This application is based upon and claims the benefit of priority from the prior Japanese Patent Application No. 2004-208130 (filed Jul. 15, 2004); the entire contents of which are incorporated herein by reference.

### BACKGROUND OF THE INVENTION

1. Field of the Invention

The present invention relates to a flow path structure applied to a compact reactor, a production method thereof, and a fuel cell system using the flow path structure.

2. Description of the Related Art

Compact reactors having flow path structure therein are now under active development. Such compact reactors can be preferably applied to various compact devices such as a cellular phone and, as well, have another advantages. The following advantages are recited in Japanese Patent Application Laid-open No. 2003-88754 in a paragraph [0006].

(1) The reaction volume in the reaction flow path is made smaller, thereby the effect of the ratio of the surface area to the volume becomes prominent. This leads to an advantage that a property of thermal conduction at a time of catalytic reaction is improved and reaction efficiency is improved.

(2) Time of diffusion and mixing of the reaction molecules composing the mixed substances is made shorter. This leads to another advantage that rate of progress (rate of reaction) of catalytic reaction in the reaction flow path is improved.

(3) The other advantage is that a plurality of structures each including the reaction flow path are layered with each other so that any complicated study in view of the reaction engineering with respect to scale-up (enlargement of the scale of the device or increase in production capacity of fluid substances) is unnecessary.

A usual flow path structure is, as described in the above citation, comprised of a small substrate of silicon or such and a sealing substrate of glass or such. The small substrate, as described in a paragraph [0031] of the citation, has grooves on one surface thereof, which are etched into arbitrary groove shapes by a photo-etching technique and such. A catalyst of a copper-zinc family is formed and adhered on inner surfaces of the grooves by a CVD method and such. The sealing substrate is joined to the small substrate, as opposing to the surface having the grooves. Thereby the flow path having the catalyst therein is formed.

The usual flow path is adapted to laboratory uses, however, not adapted to mass production for general uses. The reason is that high aspect ratio (a ratio of depth to width) required for such grooves cannot be achieved in high productivity by the usual photo-etching technique or machining techniques.

### SUMMARY OF THE INVENTION

The present invention is intended for providing a flow path structure capable of being produced in high productivity, a production method thereof having high productivity, and a fuel cell system using the flow path structure.

According to a first aspect of the present invention, a flow path structure is provided with: a first flow path member having a plurality of through grooves, the through grooves being disposed adjacent to each other; a second flow path member having a fitting portion, in the fitting portion the first flow path member being fitted; a third flow path member covering the fitting portion so as to be sealed, the third flow path member being provided on the second flow path member; an inflow port to receive a fluid; an outflow port to exhaust an exhaust fluid; and a flow path formed in the fitting portion along the first flow path member, the flow path linking the inflow port and the outflow port and running through the through grooves.

According to a second aspect of the present invention, a production method of a flow path structure comprises forming a catalyst supported on through grooves of a first flow path member; fitting the first flow path member supporting the catalyst in a second flow path member having a fitting portion, an inflow port and an outflow port to form a flow path along the first flow path member so that the flow path links the inflow port and the outflow port and runs through the through grooves; and uniting the third flow path member with the second flow path member by welding so that the fitting portion is covered and sealed.

According to a third aspect of the present invention, a fuel cell system is provided with a first flow path member having a plurality of through grooves, the through grooves being disposed adjacent to each other; a second flow path member having a fitting portion, in the fitting portion the first flow path member being fitted; a third flow path member covering the fitting portion so as to be sealed, the third flow path member being provided on the second flow path member; an inflow port to receive a fluid; an outflow port to exhaust an exhaust fluid; a flow path formed in the fitting portion along the first flow path member, the flow path linking the inflow port and the outflow port and running through the through grooves; a fuel supplier supplying the a fuel to the through grooves; a catalyst reforming the fuel into a gas including hydrogen, the catalyst being supported on the through grooves; and a fuel cell using the gas to generate electricity.

### BRIEF DESCRIPTION OF THE DRAWINGS

FIGS. 1 through 3 are exploded perspective views of a flow path structure according to a first embodiment of the present invention;

FIG. 4 is a side view of a micro-channel applied to a flow path structure according to a second embodiment of the present invention;

FIG. 5 is a side view of a micro-channel applied to a flow path structure according to a third embodiment of the present invention;

FIG. 6 is an exploded perspective view of a flow path structure according to a fourth embodiment of the present invention;

FIGS. 7A and 7B are sectional views of a flow path structure according to a fifth embodiment of the present invention;

FIG. 8 is an exploded perspective view of a flow path structure according to a sixth embodiment of the present invention;

FIG. 9A is an exploded perspective view of a flow path structure according to a seventh embodiment of the present invention and FIG. 9B is a perspective view of a micro-channel applied thereto;

FIGS. 10A through 10C are respectively a top view, a side sectional view and a bottom view of a fuel cell system according to an eighth embodiment of the present invention;

FIG. 11 is a block diagram of the fuel cell system according to the eighth embodiment of the present invention;

FIG. 12 is an exploded perspective view of a flow path structure according to a modification of the first embodiment of the present invention;

FIGS. 13A, 13B, 14A and 14B are schematic drawings showing combinations of the flow path structures; and

FIG. 15 is a perspective view of a micro-channel according a modified version.

### DETAILED DESCRIPTION OF THE INVENTION

Throughout the present description and claims, a term “through groove” means a groove formed on an object having a first side and a second side and penetrating the first side through the second side.

### First Embodiment

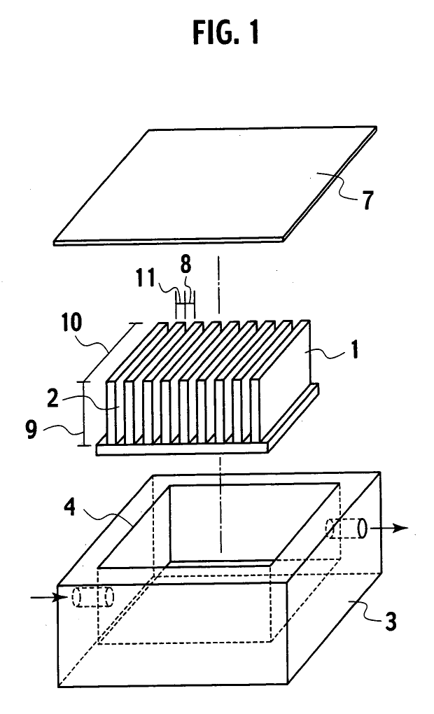

A first embodiment of the present invention will be described hereinafter with reference to FIGS. 1 to 3.

A micro-channel 1 (a first flow path member) is formed from amass of base material by machining. Since higher thermal conductivity is preferable at a time of catalytic reaction, the micro-channel 1 is preferably, at least in part, made of any highly thermally conductive base material for improvement of thermal conductivity. As such a base material, aluminum, copper, aluminum alloys and copper alloys can be exemplified. As well, these materials are further preferable in view of machinability. Stainless steels are also preferable as the base material because of its excellent corrosion resistance which leads to long-term applicability of the micro-channel 1, though the thermal conductivity is not so high as compared with the above materials.

The micro-channel 1 is provided with a plurality of through grooves 2 on one face thereof, each of which penetrates the micro-channel 1 from one side to the other side. The through grooves 2 are adjacent to each other. The through grooves 2 are preferably formed by usual machining or forming the base material.

As an example of usual machining, electrical discharge machining using a wire (wire-cutting) can be exemplified. The wire-cutting is accomplished by generating electrical discharge between a tool electrode of a thin metal wire and an object for machining and moving the tool electrode or the object correspondingly to an objective shape. Alternatively, abrasive machining using a disc blade made of abrasive particles such as diamond particles solidified with resin can be applied. The abrasive machining is accomplished by rotating the disc blade at high speed and then touching and moving the disc blade to an object so that portions where the rotating disc blade touches are worn off to give an objective shape. The wire-cutting and the abrasive machining are very adapted to forming grooves having opened both ends, such as the through grooves 2, in a short time.

As an example of usual forming, forging can be exemplified. The forging is accomplished by pressing and deforming a bar or a bulk of metal with a die or a tool so that the bar or the bulk forms an objective shape. The forging provides the metal with hardening so as to improve mechanical properties thereof, as well as deformation of the metal so as to obtain an objective shape. Alternatively, casting can be applied. The casting is accomplished by pouring molten metal into a casting die having a cavity of an objective shape and removing the casting die after enough cooling so that the objective shape of the metal is obtained. The forging and the casting are very adapted to forming complex shapes such as the micro-channel 1.

A catalyst is supported on inner surfaces of the through grooves 2. Provided that the flow path structure is applied to reforming methanol, dimethyl ether and such to obtain hydrogen, catalysts including Pt or Cu—Zn are preferable. The catalyst including Pt is particularly preferable since it is excellent in corrosion resistance and oxidation resistance.

Forming the catalyst supported on the through grooves 2 is accomplished by the following steps. In a case where the surfaces of the micro-channel 1, which includes the inner surfaces of the through grooves 2, are formed of an aluminum alloy, the surfaces of the micro-channel 1 are anodized. The anodized surfaces are next subject to any of publicly known methods as forming a catalyst layer on a support, for example a wash-coating method, a sol-gel method and an impregnation method, to form the catalyst supported on the anodized inner surfaces of the through grooves 2. In a case where the surfaces of the micro-channel 1 are formed of a stainless steel, the micro-channel 1 is baked at a high temperature so that roughness of the surfaces of the micro-channel 1 including the inner surfaces of the through grooves 2 is increased. The surfaces having greater roughness are next subject to a publicly known method for forming a catalyst layer on a support, which will be described later, to form the catalyst supported on the surfaces.

A flow path block 3 (a second flow path member) is formed from a mass of base material by machining. Similar to the micro-channel 1, the flow path block 3 is preferably, at least in part, made of any highly thermally conductive base material for improvement of thermal conductivity. As such a base material, aluminum, copper, aluminum alloys and copper alloys can be exemplified. As well, these materials are further preferable in view of machinability. Stainless steels are also preferable as the base material because of its excellent corrosion resistance which leads to long-term applicability of the flow path block 3, though the thermal conductivity is not so high as compared with the above materials.

The flow path block 3 is provided with a fitting portion 4, which is a recess formed in the flow path block 3 and the micro-channel 1 is fitted into. A lid 7 (a third flow path member, later described) is united on the flow path block 3 after fitting the micro-channel 1 in the flow path block 3. The fitting portion 4 is formed in such a way as to form a flow path when the fitting portion 4 is sealed with the lid 4, if need arises, by welding the micro-channel 1 with the flow path block 3 and further welding the flow block 3 with the lid 7.

FIGS. 2 and 3 show examples of relations between the micro-channel 1 and the fitting portion 4. According to FIG. 2, the micro-channel 1 is formed to have a rectangular bottom surface having sides of a length A and the fitting portion 4a is formed to be a recess, side walls of which corresponding to the sides of the micro-channel 1 have a length B longer than the length A. Thereby a clearance is formed between the micro-channel 1 fitting in the fitting portion 4 and the side walls of the fitting portion 4a of the flow path block 3. The flow path block 3 is further provided with through holes 5a as an inflow port and 5b as an outflow port respectively linking with the clearance. By uniting the lid 7 with the flow path block 3 so that the fitting portion 4 is covered and sealed, the flow path structure is formed to have flow paths in the fitting portion 4a along the micro-channel 1 so as to link the through holes 5a and 5b as the inflow port and the outflow port and form parallel flow paths through the through grooves 2.

According to FIG. 3, a fitting portion 4b is formed to be a recess, a shape of which corresponds to the rectangular bottom shape of the micro-channel 1. The micro-channel 1 is fitted in the fitting portion 4b. The flow path block 3 is further provided with linking grooves 6 which respectively link adjacent pairs of the through grooves 2. The linking grooves 6 are formed in such a way that the through grooves 2 are serpentinely linked with each other via the linking grooves 6 and hence the through grooves 2 and the linking grooves 6 in combination form a single serpentine flow path. The through holes 5a and 5b are disposed at substantially both ends of the serpentine flow path.

The flow path block 3 is formed from a mass of base material by the usual machining method or the usual forming method. The electrical discharge machining method, a milling machining method and such can be employed as the machining method. The forging method and the casting method are employed as the forming method. Moreover, for example forming the flow path block 3 can be accomplished by first casting a base block for the flow path block 3 without the fitting portion 4, the through holes 5a and 5b and the linking grooves 6, next machining the base block to form the fitting portion 4, the through holes 5a and 5b and the linking grooves 6. As such, the machining method and the forming method can be employed in combination.

The aforementioned lid 7 is configured to cover the fitting portion 4 so as to be sealed and provided on the flow path block 3. The lid 7 is preferably, at least in part, made of any highly thermally conductive base material for improvement of thermal conductivity. As such a base material, aluminum, copper, aluminum alloys and copper alloys can be exemplified. Stainless steels are also preferable as the base material because of its excellent corrosion resistance which leads to long-term applicability of the micro-channel 1, though the thermal conductivity is not so high as compared with the above materials.

More specifically, the lid 7 is configured to cover any openings exposed outward, except for the through holes 5a and 5b, of the flow path block 3. By uniting the lid 7 with the flow path block 3, the flow path structure is formed to have flow paths in the fitting portion 4b along the micro-channel 1 so as to link the through holes 5a and 5b and form a serpentine flow path through the through grooves 2 and the linking grooves 6.

For covering and sealing the fitting portion 4, the lid 7 is united with the flow path block 3 by welding. However, any extremely high temperature in the course of the welding may give rise to sintering of the catalyst supported on the micro-channel 1. There, the sintering means fusion of particles of the catalyst to form larger particles and hence leads to decrease in exposed surface area of the catalyst, namely decrease in number of active sites on the catalyst, and change in surface structure of the catalyst. (see “SHOKUBAI-KOZA volume 5^{th}, VOLUME OF OPTICS 1, CATALYST DESIGN”, edited by CATALYSIS SOCIETY of JAPAN, published by KODANSHA on Dec. 10, 1985)

Provided that the catalyst is subject to sintering, catalytic activity may decrease. Therefore, the welding at the uniting step is preferably achieved in such a way that a temperature of the catalyst does not reach a sintering temperature where the catalyst is sintered. For example, a catalyst containing Pt has a sintering temperature not so greater than 500 degrees C. Any welding method capable of local heating such as laser-beam-welding or ultrasonic-welding is preferably employed.

Moreover, preferably, conditions of the laser-beam-welding or the ultrasonic-welding are preferably regulated so that the temperature of the catalyst containing Pt does not reach the sintering temperature of 500 degrees C. Provided that an aluminum of A1050 regulated in JIS regulation is applied to the flow path block 3 and the lid 7, laser-beam-welding of the lid 7 with the flow path block 3 is accomplished in the following conditions. According to the inventors' experiment, a YAG laser apparatus (600 W in output power, 1 μm in diameter of a laser beam) was applied to a welding apparatus. The conditions were regulated to be 520 W in peak value, 100 W in every pulse, 10 pulses per second and then laser-beam-welding was achieved. In the course of welding, the temperature of the catalyst was constantly below 500 degrees C. and seams is less than 70% in the overlap ratio, thereby good welding could be accomplished.

Alternatively, ultrasonic-welding of the lid 7 with the flow path block 3 is accomplished in the following conditions. According to the inventors' experiment, an oscillator of 3 kW in output power and 20 kHz in frequency was applied to a welding apparatus. A horn was pressed to a portion objective to welding with a facial pressure of 3 to 4 kgf/cm² and an ultrasonic wave was applied for 0.6 sec. In the course of welding, the temperature of the catalyst was constantly below 500 degrees C. and good welding could be accomplished.

The flow path structure such constituted is capable of being produced in higher productivity as compared with any of flow path structures of prior arts since the flow path structure is provided with the flow path block 3 having the fitting portion 4 and the micro-channel 1 having the through grooves 2. For example, provided that a micro-channel 1 is formed by wire-cutting in such a way that, with respect to the through grooves 2, a width 8 and a depth 9 are respectively 0.25 mm and 10 mm, which give an aspect ratio of 40, a length 10 is 30 mm, an interval 11 between adjacent pairs of the through grooves 2 is 0.3 mm and a number of the through grooves 2 is 40, the wire-cutting can be accomplished for about 2 hours. More specifically, the flow path structure of the present embodiment of the present invention is capable of being produced for one third of time with fourteen times greater in the aspect ratio of the flow path as compared with the prior arts using photo-etching, and for one sixth of time with five time greater in the aspect ratio as compared with the prior arts using machining.

The through grooves 2 are so formed that surplus catalyst component or liquid drops adhered on the inner surfaces of the through grooves 2 can be easily removed by blowing high-pressure air or such. Thereby, clogging of the flow path, fluctuation of pressure loss and sintering are suppressed.

Moreover, since the micro-channel 1 is separated from the flow path block 3, the micro-channel 1 and the flow path block 3 can be independently modified and then combined depending on applications of the flow path structure. For example, provided that the flow path structure is used as a reactor, different types of micro-channels 1 respectively optimized to specific SV values of reactions and one type of a flow path block 3 are prepared in advance and, by selecting therefrom and combining, a flow path structure having a SV value required for an objective reaction can be provided. There SV value means a spatial speed of a treated amount in the reactor per unit time divided by a volume of a flow path where the reaction occurs. More specifically, this leads to unitization and standardization of parts.

The aforementioned description is given to the present embodiment in which the micro-channel 1 is simply fitted in the flow path block 3, however, the micro-channel 1 may be joined with the flow path block 3 by welding such as laser-beam-welding or ultrasonic-welding. Conditions of welding are preferably regulated so that the temperature of the catalyst does not reach the sintering temperature thereof, as in a manner similar to the case of the aforementioned welding between the flow path block 3 and the lid 7. If the micro-channel 1 is welded with the flow path block 3, they are tightly in contact and hence thermal resistance between a fluid flowing through the through grooves 2 and the flow path block 3 is decreased. This leads to increase in thermal conduction between the fluid and the exterior and hence leads to improvement of thermal efficiency and prevention of generation of hot spots. Thereby a safe and highly effective flow path structure can be provided.

Moreover, the aforementioned description is given to the present embodiment in which the lid 7 is not combined with the flow path block 3, however, the lid 7 may be joined with the flow path block 3 by welding such as laser-beam-welding or ultrasonic-welding. Conditions of welding are preferably regulated so that the temperature of the catalyst does not reach the sintering temperature thereof, as in a manner similar to the case of the aforementioned welding between the flow path block 3 and the lid 7. Similarly to the aforementioned case where the micro-channel 1 is welded with the flow path block 3, thermal resistance between a fluid flowing through the through grooves 2 and the lid 7 is decreased, thereby a safe and highly effective flow path structure can be provided.

Furthermore, the micro-channel 1 and the lid 7 may be formed in a unitary body. If the micro-channel 1 and the lid 7 are formed in a unitary body, similar effects as mentioned above can be obtained.

### Second Embodiment

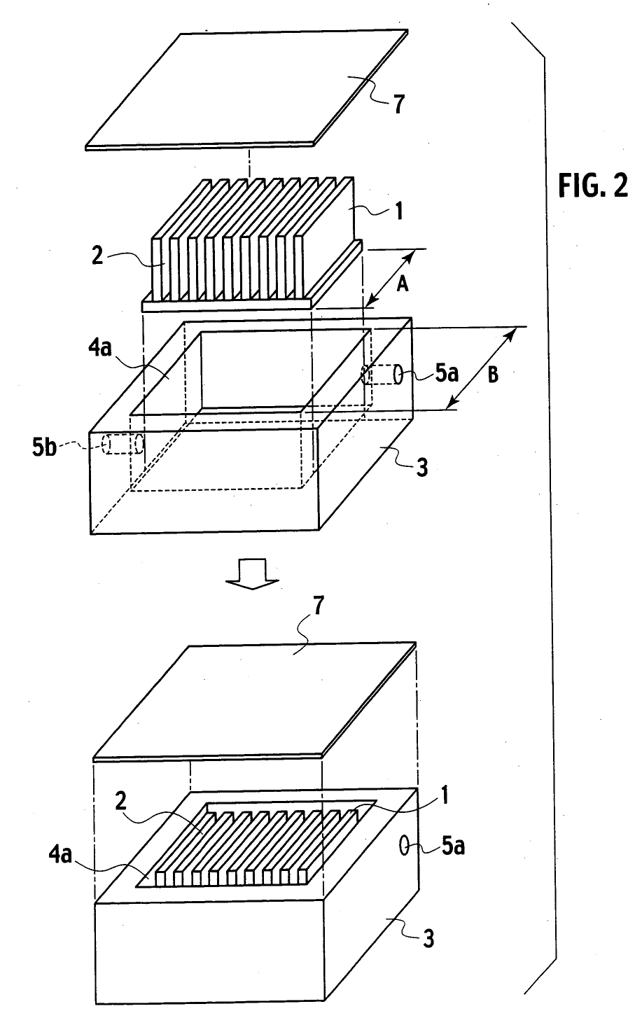

A second embodiment of the present invention will be described hereinafter with reference to FIG. 4. In the following description, substantially the same elements as any of the aforementioned elements are referenced with the same numerals and the detailed descriptions will be omitted. Moreover, any elements except for the micro-channel 1b are identical to them of the aforementioned description and the detailed descriptions will be omitted.

A micro-channel 1b (a first flow path member) is formed from a mass of base material by machining. As similar to the micro-channel 1 of the first embodiment, the micro-channel 1b is preferably, at least in part, made of any highly thermally conductive base material for improvement of thermal conductivity. The micro-channel 1b is comprised of wave-like inner surfaces to form a plurality of through grooves 2b therebetween. Similarly to the aforementioned first embodiment, the catalyst is supported on inner surfaces of the through grooves 2b.

The micro-channel 1b is preferably formed by wire-cutting. The wave-like surfaces of the through grooves 2b are formed by moving a tool electrode of a thin metal wire wave-likely in the lateral direction and linearly in the depth direction of the through grooves 2b.

Such constituted flow path structure has a greater contact area with respect to the fluid flowing through the through grooves 2b than one of the flow path structure of the first embodiment. Thereby thermal resistance between a fluid flowing through the through grooves 2b and the micro-channel 1b is decreased. More specifically, as similar to the modifications of the first embodiment, this leads to improvement of thermal efficiency and prevention of generation of hot spots. Thereby a safe and highly effective flow path structure can be provided. Furthermore, reaction efficiency is improved because of the increase in the greater contact area.

### Third Embodiment

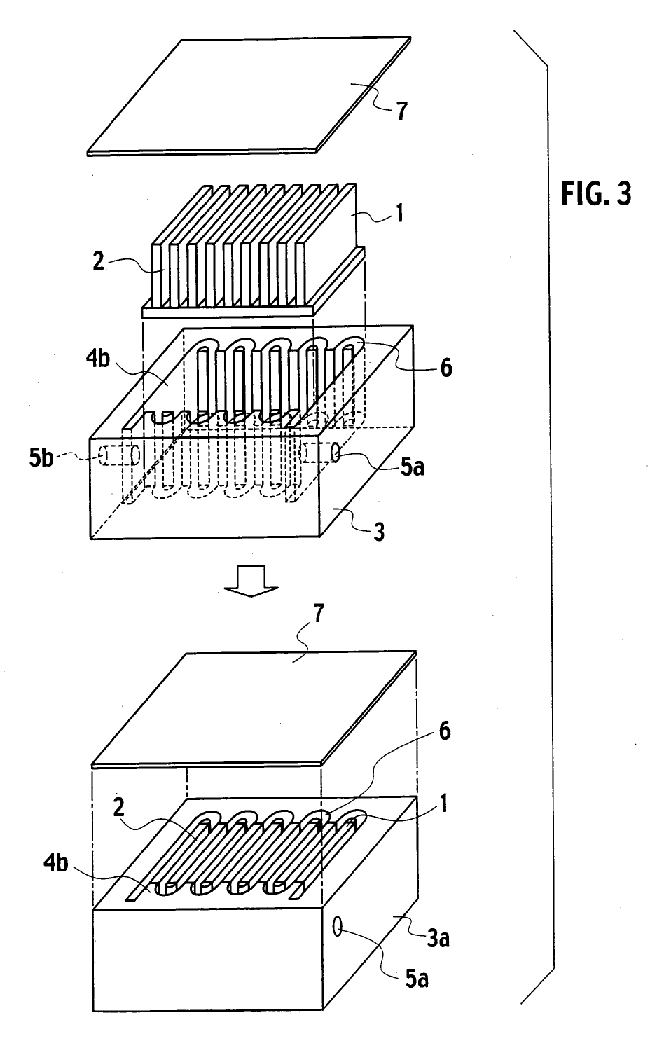

A third embodiment of the present invention will be described hereinafter with reference to FIG. 5. In the following description, substantially the same elements as any of the aforementioned elements are referenced with the same numerals and the detailed descriptions will be omitted. Moreover, any elements except for the micro-channel 1c are identical to them of the aforementioned description and the detailed descriptions will be omitted.

A micro-channel 1c (a first flow path member) is formed from a mass of base material by machining. As similar to the micro-channel 1 of the first embodiment, the micro-channel 1c is preferably, at least in part, made of any highly thermally conductive base material for improvement of thermal conductivity. The micro-channel 1c is comprised of wedge-shaped projections to form a plurality of through grooves 2c therebetween. More specifically, the through grooves 2c are tapered toward these bottoms. The micro-channel 1c is preferably formed by casting with a casting mold having a shape complementary to the wedge-shaped projections. Similarly to the aforementioned first embodiment, the catalyst is supported on inner surfaces of the through grooves 2c.

According to such constituted flow path structure, since intervals between adjacent pairs of through grooves 2c are wider toward the bottom of the through grooves 2c, heat capacity and cross sectional area of the through grooves 2c are greater toward the bottom. Thereby thermal resistance between the walls of the through grooves 2c and the bottom of the micro-channel 1c is decreased. More specifically, as similar to the modifications of the first embodiment, this leads to improvement of thermal efficiency and prevention of generation of hot spots. Thereby a safe and highly effective flow path structure can be provided. Moreover, according to the micro-channel 1, the casting mold is easy to be removed and hence the flow path structure provides higher productivity. Further, since uniformity of temperature is improved, reaction efficiency is improved.

### Fourth Embodiment

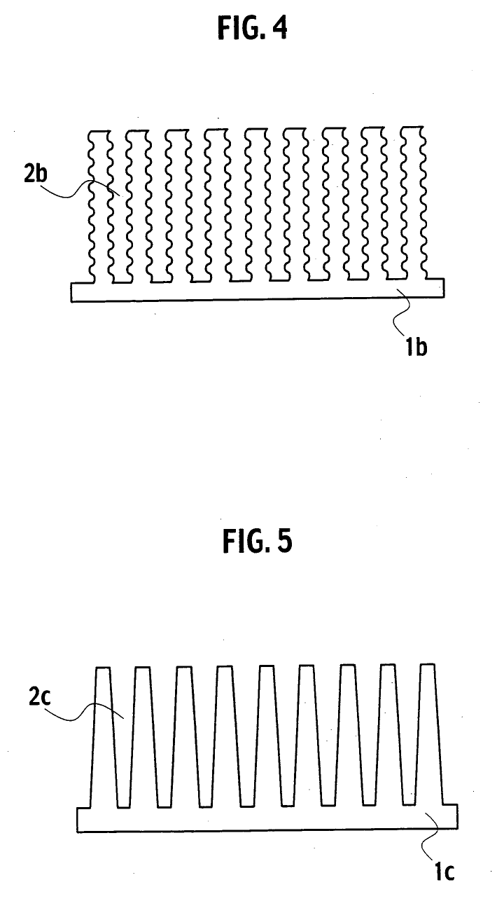

A fourth embodiment of the present invention will be described hereinafter with reference to FIG. 6. In the following description, substantially the same elements as any of the aforementioned elements are referenced with the same numerals and the detailed descriptions will be omitted.

A flow path block 3 (a second flow path member) is composed of two members of a side wall 3a having openings at top and bottom faces thereof and a bottom plate 3b. As similar to the micro-channel 1 of the first embodiment, the side wall 3a and the bottom plate 3b are preferably, at least in part, made of any highly thermally conductive base material for improvement of thermal conductivity. The bottom plate 3b is welded with the bottom face of the side wall 3a by laser-beam-welding or ultrasonic-welding.

The side wall 3a can be made from a rectangular pillar having a rectangular cavity therein of the base material. The cavity will become a fitting portion 4c. Such the pillar can be formed by extrusion-forming of aluminum. Cutting the pillar in part and drilling are accomplished to form through holes 5a and 5b.

Such constituted flow path structure is provided with the flow path block 3 composed of two members of the side wall 3a and the bottom plate 3b. Thereby machining of the fitting portion 4c is easily accomplished as compared with the first embodiment. Various sizes of the rectangular pillars having the rectangular cavities are commercially available. Such the pillar is unnecessary to be largely machined as compared with the first embodiment. Therefore, the flow path block 3 provides high productivity as well as the micro-channel 1.

### Fifth Embodiment

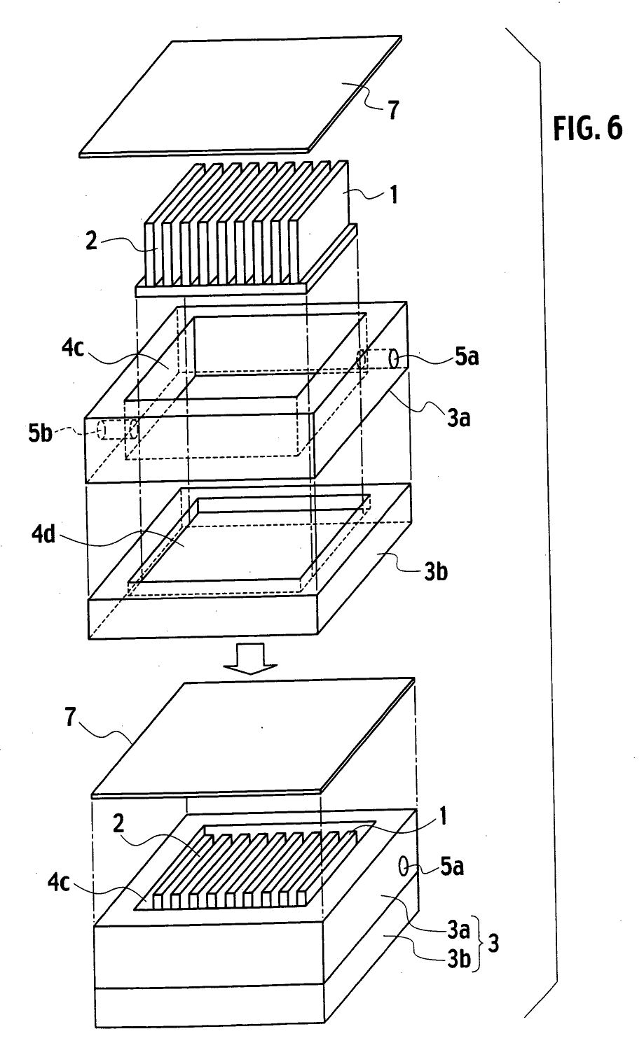

A fifth embodiment of the present invention will be described hereinafter with reference to FIGS. 7A and 7B. In the following description, substantially the same elements as any of the aforementioned elements are referenced with the same numerals and the detailed descriptions will be omitted.

A micro-channel 1d (a first flow path member) is formed from a mass of base material by machining. As similar to the micro-channel 1 of the first embodiment, the micro-channel 1d is preferably, at least in part, made of any highly thermally conductive base material for improvement of thermal conductivity. As in a similar manner to the third embodiment, the micro-channel 1d is comprised of wedge-shaped projections to form a plurality of through grooves 2d therebetween. More specifically, the through grooves 2d are tapered toward these bottoms. The micro-channel 1d is preferably formed by casting with a casting mold having a shape complementary to the wedge-shaped projections. Similarly to the aforementioned first embodiment, the catalyst is supported on inner surfaces of the through grooves 2d.

Moreover, the micro-channel 1d is formed to be capable of engaging with another micro-channel 1d if the pair of the micro-channels 1d are oriented face to face as shown in FIG. 7B. In the present embodiment, the pair of the micro-channels 1d are engaged with each other and applied. The wedge-shaped projections of the one micro-channel 1d are respectively, to some extent, inserted and fitted in the through grooves 2d of the other micro-channel 1d. In this engaging state, the micro-channels 1d are fitted in the flow path block 3 composed of the side wall 3a and the bottom plate 3b.

According to such constituted flow path structure, since intervals between adjacent pairs of through grooves 2d are wider toward the bottom of the through grooves 2d, heat capacity and cross sectional area of the through grooves 2d are greater toward the bottom. Thereby thermal resistance between the walls of the through grooves 2d and the bottom of the micro-channel 1c is decreased. More specifically, as similar to the third embodiment, this leads to improvement of thermal efficiency and prevention of generation of hot spots. Thereby a safe and highly effective flow path structure can be provided. Moreover, according to the micro-channel 1d, the casting mold is easy to be removed and hence the flow path structure provides higher productivity.

Further, since a wider contact area between the lid 7 and the micro-channel 1d is assured as compared with the cases of the first and third embodiments, thermal resistance between the lid 7 and the micro-channel 1d is decreased. More specifically, this leads to improvement of thermal efficiency and prevention of generation of hot spots and thereby a safe and highly effective flow path structure can be provided.

### Sixth Embodiment

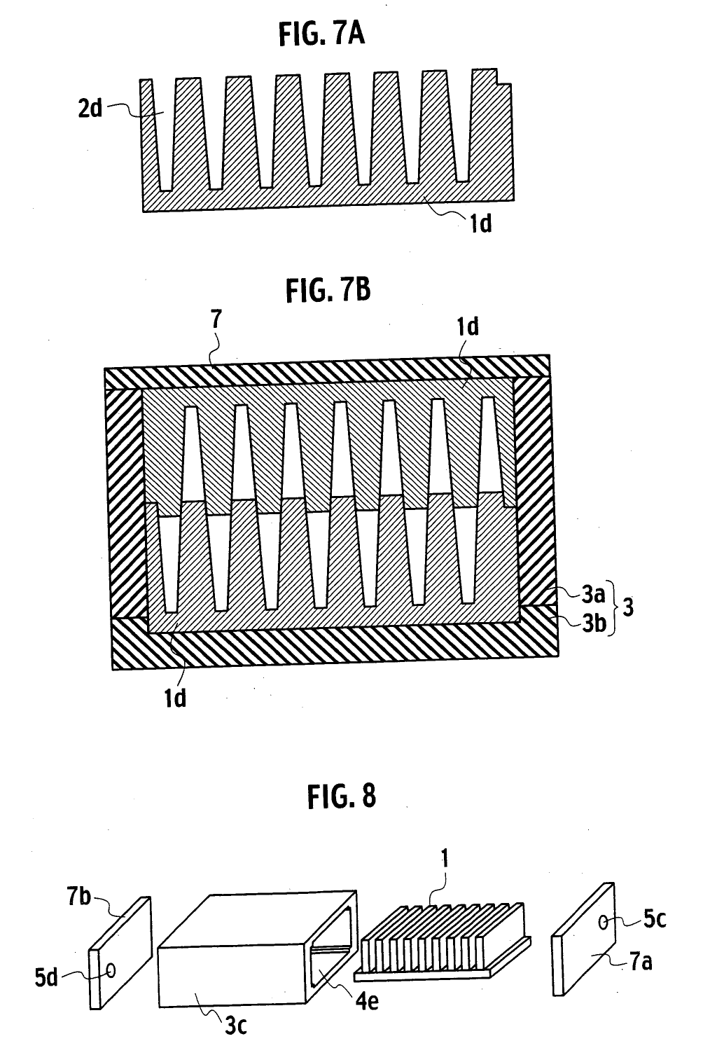

A sixth embodiment of the present invention will be described hereinafter with reference to FIG. 8. In the following description, substantially the same elements as any of the aforementioned elements are referenced with the same numerals and the detailed descriptions will be omitted.

The flow path block 3c (a second flow path member) is formed from a mass of base material by machining. As similar to the side wall 3a of the fourth embodiment, the flow path block 3c is provided with a fitting portion 4e as a cavity formed in the flow path block 3c but has openings at both ends.

The flow path block 3c can be made from a rectangular pillar having a rectangular cavity therein of the base material by cutting the pillar in part. The cavity will become the fitting portion 4e. Such the pillar can be formed by extrusion-forming of aluminum. The flow path block 3c is preferably, at least in part, made of any highly thermally conductive base material for improvement of thermal conductivity.

The micro-channel 1 is fitted in the fitting portion 4e and lids 7a and 7b (third flow path members) are attached on both ends of the fitting portion 4e so as to seal both openings. The lids 7a and 7b are respectively provided with through holes 5c (an inflow port) and 5d (an outflow port). In this way, by attaching the lids 7a and 7b to the fitting portion 4e housing the micro-channel 1, the flow path structure is formed to have flow paths in the fitting portion 4 along the micro-channel 1 so as to link the through holes 5c and 5b and form parallel flow paths through the through grooves 2.

According to the flow path as such constituted, the flow path block 3 has a rectangular tubular shape having a cavity therein. Thereby the fitting portion can be more easily formed as compared with the case of the first embodiment because it can be easily formed from a rectangular tubular pillar. Such the pillars having the cavities are commercially available and various sizes thereof are in circulation. Moreover, length of united portion between the lids 7a and 7b and the fitting portion 4e is relatively short, thereby time for uniting process can be decreased. Therefore, the flow path structure provides high productivity with respect to forming the flow path block 3c as well as the micro-channel 1.

### Seventh Embodiment

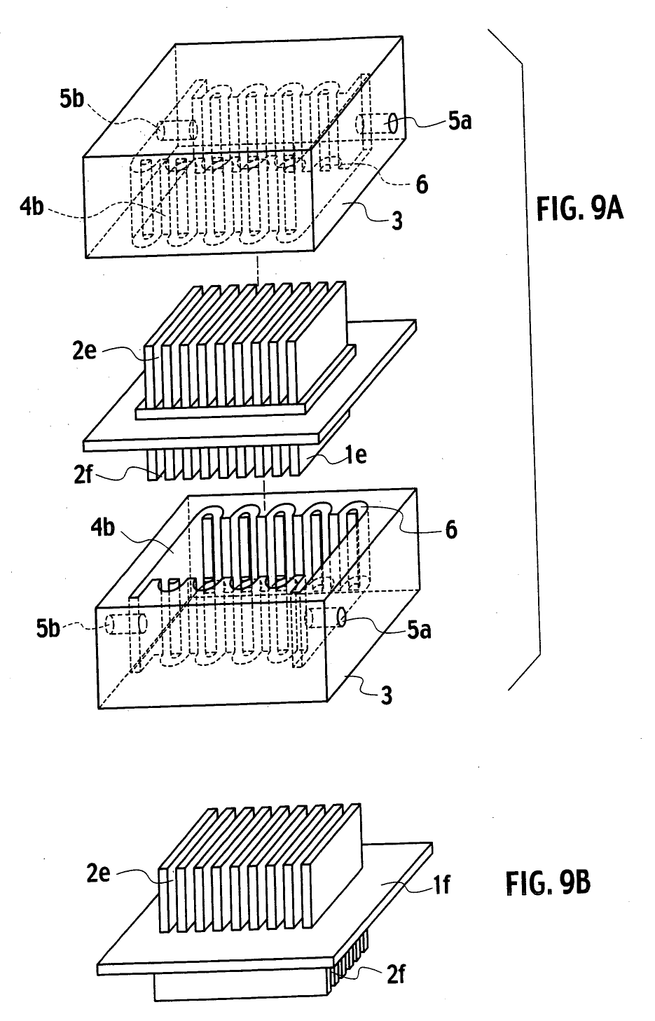

A seventh embodiment of the present invention will be described hereinafter with reference to FIGS. 9A and 9B. In the following description, substantially the same elements as any of the aforementioned elements are referenced with the same numerals and the detailed descriptions will be omitted.

A micro-channel 1e is provided with two groups of through grooves 2e and 2f on both faces thereof. Each of the through grooves 2e and 2f penetrates the micro-channel 1e from one side to the other side. The micro-channel 1e is preferably made of any highly thermally conductive base material for improvement of thermal conductivity.

The through grooves 2e are adjacent to each other and the through grooves 2f are also adjacent to each other. Moreover, the through grooves 2e are substantially parallel to the through grooves 2f. The parallelism thereof may have, for example, an error of ±1° caused by a machining error in general. The catalyst is supported on inner surfaces of the through grooves 2e and 2f, similarly to the first embodiment.

In the present embodiment, a pair of the flow path blocks 3 is used (one is as a second flow path member and the other is as a third flow path member). The micro-channel 1e is fitted in the fitting portions 4 of the flow path blocks 3 in such a way that the through grooves 2e are housed in the first flow path block 3 and the through grooves 2f are housed in the second flow path block 3. Faces of the flow path blocks 3, where the fitting portions 4 are formed, and the micro-channel 1e are in part joined with each other. By uniting the pair of the flow path flocks 3 with each other so that the fitting portions 4 are covered and sealed, the flow path structure is formed to have two independent systems of flow paths respectively in the fitting portions 4 along the micro-channel 1e. Each of the two systems of the independent flow paths links the through holes 5a and 5b as the inflow port and the outflow port and form parallel flow paths through the through grooves 2e or 2f.

The two systems of the flow paths are separated only by a wall between the through grooves 2e and 2f. Therefore thermal resistance between the two systems is extremely low. More specifically, the two systems of the flow paths efficiently exchange heat with each other. This leads to high energy efficiency particularly in a case where an exothermic reaction occurs in one of the systems and an endothermic reaction occurs in the other because the systems exchange heat between these reactions and hence a heat exchange with the exterior becomes extremely small.

Alternatively, the through grooves 2e can be disposed substantially perpendicular to the through grooves 2f as shown in FIG. 9B. Though the through grooves 2e and 2f may weaken and soften the micro-channel 1e in the respective directions, since they are disposed perpendicularly to each other, the micro-channel 1e becomes insusceptible of being curved in any direction. In a case where the flow path structure is used in a high-temperature atmosphere, for example beyond 300 degrees C., the high-temperature may give rise to curvature of the micro-channel 1e because of an internal stress thereof. In such a case, the perpendicular disposition provides insusceptibility of curvature of the flow path structure. The perpendicularity thereof may have, for example, an error of ±1° caused by a machining error in general.

### Eight Embodiment

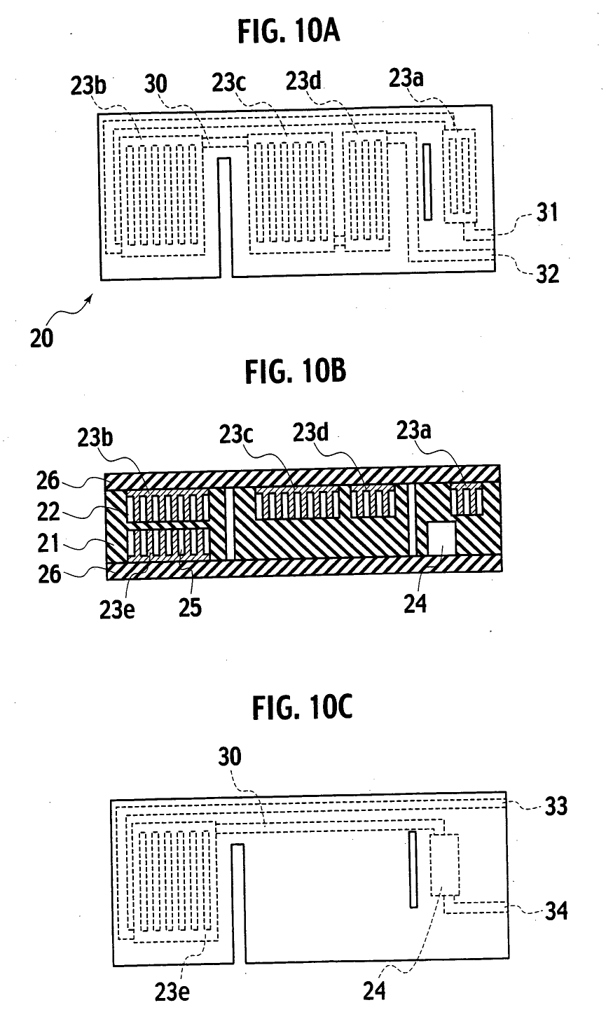

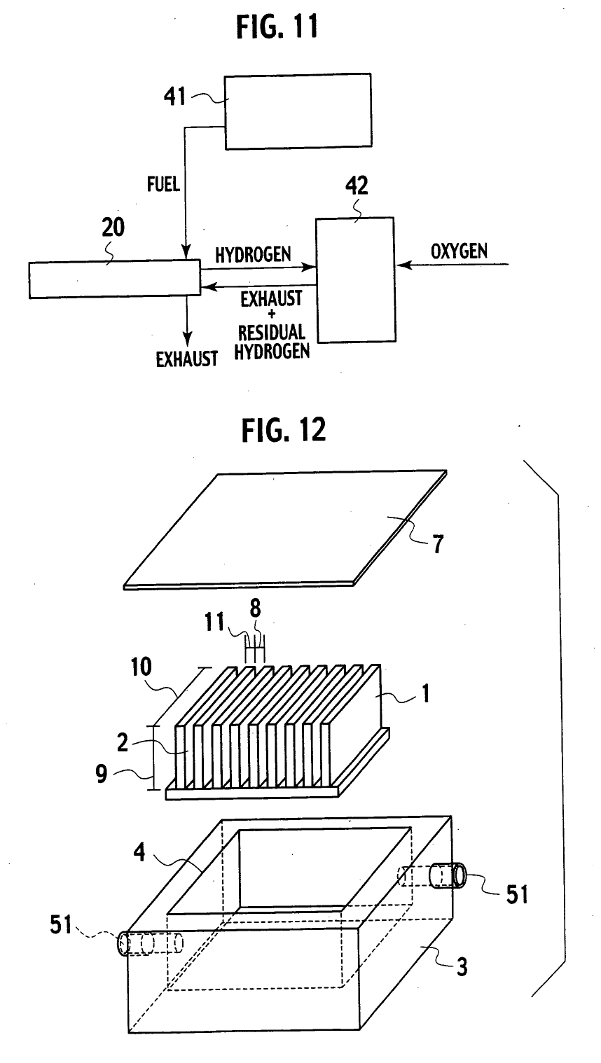

An eighth embodiment of the present invention will be described hereinafter with reference to FIGS. 10A through 10C and 11. In the following description, substantially the same elements as any of the aforementioned elements are referenced with the same numerals and the detailed descriptions will be omitted.

A flow path block 21 (a second flow path member) is formed by usual machining as similar to the flow path block 3 of the first embodiment. The flow path block 21 is preferably, at least in part, made of any highly thermally conductive base material for improvement of thermal conductivity. The flow path block 21 is provided with a fitting portion 22 to which micro-channels 23a to 23e, described later, are fitted, and a cooling portion 24 as a space for cooling an exhaust of power generation. The flow path block 21 is further provided with hollows 30, through holes 31 and 33 as inflow ports and through holes 32 and 34 as outflow ports. One of the hollows 30 is formed at one face of the flow path block 21 and links the through hole 31, the fitting portion 22 and the through hole 32 to form a single flow path. The other of the hollows 30 is formed at the other face of the flow path block 21 and links the through hole 33, the fitting portion 22, the cooling portion 24 and the through hole 34 to form another single flow path.

The micro-channels 23a to 23e (a first flow path member) are fitted in the fitting portion 22. The micro-channels 23a to 23e are formed by usual machining similarly to the micro-channel 1 of the first embodiment. Each of the micro-channels 23a to 23e is preferably, at least in part, made of any highly thermally conductive material for improvement of thermal conductivity and provided with a plurality of through grooves 25.

Inner walls of the through grooves 25 of the micro-channel 23a are anodized for improvement of corrosion resistance. A fuel supplied into the through hole 31 flows through the through grooves 25 of the micro-channel 23a and a clearance between the micro-channel 23a and the fitting portion 22 and receives heat generated by combustion reaction (described later) occurring at the micro-channel 23e there to be heated and evaporate.

The micro-channel 23b, on inner surfaces of the through grooves 25 thereof, supports a catalyst to promote a reforming reaction by which the evaporated fuel is reformed into a gas including hydrogen. The fuel passing through the micro-channel 23a so as to be evaporated is heated by the heat generated by the combustion reaction and then reformed into the gas including hydrogen.

The micro-channel 23c, on inner surfaces of the through grooves 25 thereof, supports another catalyst to promote a water-gas shift reaction by which carbon monoxide as a by-product of the above reforming reaction is employed to further generate hydrogen from the fuel. Thereby, at the micro-channel 23c, the gas including hydrogen generated at the micro-channel 23b comes to contain larger content of hydrogen and smaller content of carbon monoxide.

The micro-channel 23d, on inner surfaces of the through grooves 25 thereof, supports still another catalyst to promote a selective oxidation reaction or a selective methanation reaction by which carbon monoxide content is reduced. The gas passing through the micro-channel 23c may still contain certain content of residual carbon monoxide which gives rise to corrosion of a catalyst of a later-described fuel cell. The residual carbon monoxide is decreased through the micro-channel 23d by the selective oxidation reaction or the selective methanation reaction. The gas including hydrogen, in which the carbon monoxide content is further reduced, flows out of the through hole 32 and is conducted to the fuel cell 42.

The micro-channel 23e, on inner surfaces of the through grooves 25 thereof, supports further another catalyst to promote the combustion reaction of hydrogen. The fuel cell 42 exhausts exhaust gas including residual hydrogen which is left unreacted in the fuel cell 42. The residual hydrogen is subject to the combustion reaction so as to generate heat which is utilized for heating the micro-channels 23a to 23d as described above.

At the cooling portion 24, gas flowing through the cooling portion 24 is cooled by heat exchange. Since the cooling portion 24 is linked with the micro-channel 23e, the exhaust gas after the combustion reaction at the micro-channel 23e is cooled at the cooling portion 24. For improvement of efficiency of the heat exchange, the micro-channel 23a may be fitted in the cooling portion 24a as the need arises. The exhaust gas after cooling is exhausted out of the through hole 34.

A lid 26 (a third flow path member) is united on the flow path block 22, the fitting portion 22 of which the micro-channel 23a to 23e are fitted in. The fitting portion 22 is sealed with the lid 26, if need arises, by welding the lid 26 with the flow path block 21. By sealing with the lid 26, one flow path composed of the through hole 31 as the inflow port, the micro-channels 23a to 23d and the through hole 32 as the outflow port via one of the hollows 30; and the other flow path composed of the through hole 33 as the inflow port, the micro-channel 23e, the cooling portion 24 and the through hole 34 via the other of the hollows 30; are respectively formed in a manner of overlapping. The whole of them forms a reformer 20.

Next, a fuel cell system to which the reformer 20 is applied will be described. The fuel cell system is provided with fuel supply means 41 for supplying fuel of, for example, a mixture of dimethyl-ether and water. The fuel supply means 41 is configured to keep internal pressure and houses the fuel containing gases such as the dimethyl-ether or any other gas having a greater vapor pressure than the atmospheric pressure in a state being pressurized and liquefied. The fuel supply means 41 uses the internal pressure to supply the fuel to the reformer 20.

The fuel is subject to the reforming reaction in the reformer 20 and the reformed fuel including hydrogen is supplied to the fuel cell 42. The fuel cell 42 uses the hydrogen contained in the reformed fuel and oxygen, or the air containing oxygen, to generate electricity and then exhausts carbon dioxide and water as an exhaust. The fuel cell 42 simultaneously exhausts the residual hydrogen left unreacted in the course of the electricity generation, with the exhaust, as mentioned above.

The exhaust with the residual hydrogen is re-supplied to the reformer 20 and subject to the combustion reaction for supplying heat utilized for the reforming reaction. The exhaust of the combustion reaction is cooled in the reformer and exhausted to the exterior.

The fuel cell system such constituted is capable of being produced in higher productivity as compared with fuel cell systems of prior arts. The reason is that the reformer 20 is unitized into the flow path block 21 having the fitting portion and the micro-channels 23a to 23e respectively having through grooves, any of which is adapted to being easily produced and integrated with each other. The fuel cell system provides drastic decrease in time for machining or forming the reformer 20.

The through grooves 25 of the micro-channel 23a to 23e are so formed that surplus catalyst component and liquid drops adhered on the inner surfaces of the through grooves 2 can be easily removed by blowing high-pressure air or such. Thereby, clogging of the flow path, fluctuation of pressure loss and sintering are suppressed.

The aforementioned embodiments may be modified with respect to the shapes, the component materials, the constitutions and such. For example, the first embodiment shown in FIG. 2, in which the through holes 5a and 5b are provided in the flow path block 3, may be modified into a constitution in which the through holes 5a and 5b are provided on the lid 7. Likewise, the sixth embodiment shown in FIG. 8, in which the through holes 5c and 5d are respectively formed on the lid 7a and 7b, may be modified to a constitution in which the both through holes 5c and 5d are formed on the flow path block 3c.

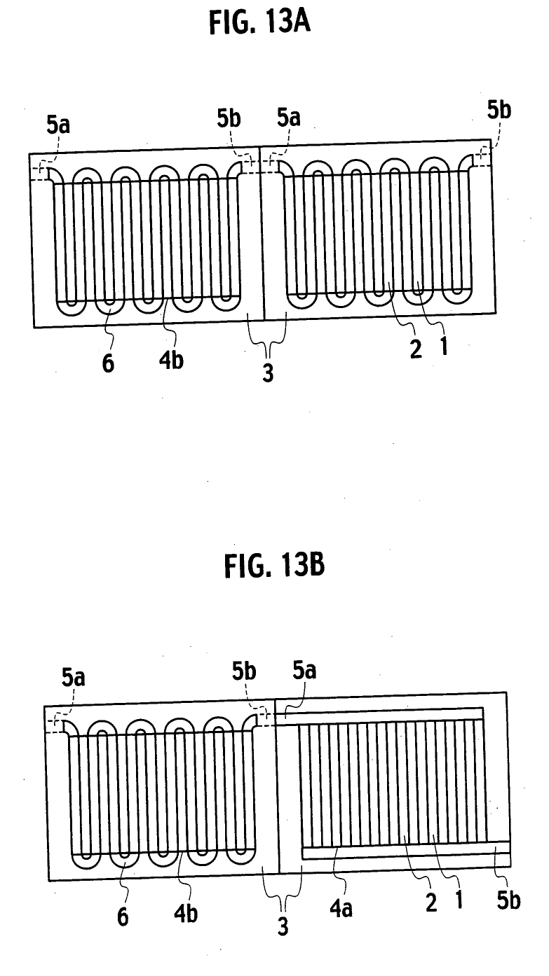

The flow path block 3 of the first embodiment may be provided with introduction tubes 51 projecting outward, as shown in FIG. 12, instead of the through holes 5a and 5b. The introduction tubes 51 may be integrally formed with the flow path block 3 by integral casting.

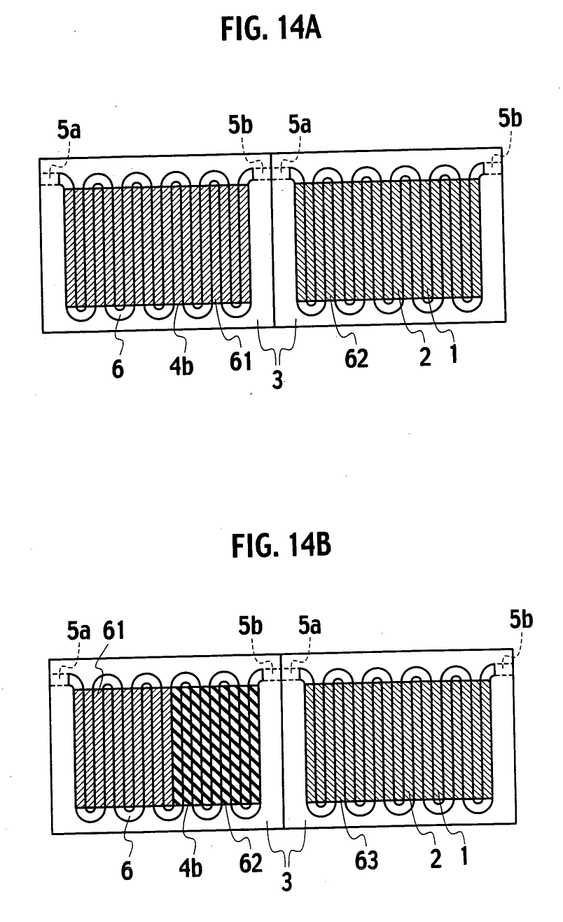

Moreover, it is possible to utilize a plurality of the flow path structures of the first embodiment in combination as shown in FIG. 13A or 13B. FIG. 13A shows an example of a combination of two identical flow path structures and FIG. 13B shows an example of a combination of two different flow path structures.

Furthermore, it is possible to utilize plural kinds of catalysts supported on the micro-channels 1 in combination as schematically illustrated in FIG. 14A or 14B. One of the flow path structures supports a first catalyst 61 and the other supports a second catalyst 62 as illustrated in FIG. 14A, where the first catalyst 61 is not identical to the second catalyst 62. Alternatively, it is possible to utilized three or more kinds of catalysts in such a way that one of the flow path structures supports a first catalyst 61 on one half thereof and a second catalyst 62 on the other half thereof and the other of the flow path structures supports a third catalyst 63 as illustrated in FIG. 14B.

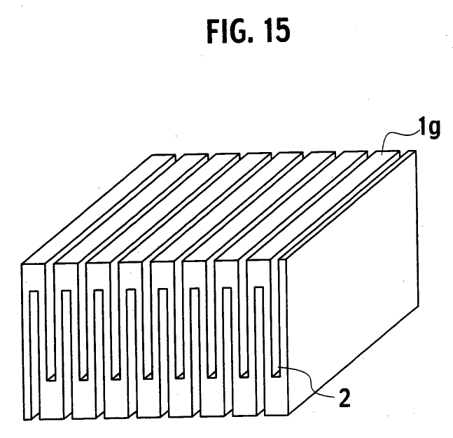

The shapes of the micro-channels 1 are not limited to what are described above and may be modified. For example, modification may be achieved in such a way as shown in FIG. 15. A micro-channel 1g according to the modification is provided with a plurality of through grooves 2 on both faces, not only on one of the faces, and the through grooves 2 on one face are alternated with the through grooves 2 on the other face. Such through grooves 2 improve quality of symmetry of the micro-channel 1g and hence contributes suppression of deformation which may occur by thermal stress or machining.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flow path structure comprising:
a first flow path member having a plurality of through grooves, the through grooves being in parallel with and disposed adjacent to each other;
a second flow path member having a fitting portion, in the fitting portion the first flow path member being fitted;
a third flow path member to seal the fitting portion, the third flow path member being provided on the second flow path member;
an inflow port to receive a fluid;
an outflow port to exhaust an exhaust fluid; and
a flow path formed in the fitting portion along the first flow path member, the flow path linking the inflow port and the outflow port and running through the through grooves.

2. The flow path structure of claim 1, wherein the flow path includes a clearance formed between the first flow path member and the second flow path member, the clearance linking the inflow port with the outflow port.

3. The flow path structure of claim 1, further comprising one or more linking grooves respectively linking adjacent pairs of the through grooves in such a way that the linking grooves and the through grooves form a single serpentine flow path.

4. The flow path structure of claim 1, further comprising a catalyst supported on the through grooves.

5. The flow path structure of claim 1, wherein the first flow path member, the second flow path member and the third flow path member at least partly consist essentially of a material selected from the group of aluminum, stainless steels, copper, aluminum alloys and copper alloys.

6. The flow path structure of claim 1, wherein the first flow path member and the second flow path member are at least partly joined together.

7. The flow path structure of claim 1, wherein the first flow path member and the third flow path member are at least partly joined together.

8. The flow path structure of claim 1, wherein the first flow path member and the third flow path member are formed in a unitary body.

9. The flow path structure of claim 1, wherein the through grooves are formed on first and second sides of the first flow path member.

10. The flow path structure of claim 9, wherein lengthwise directions of the grooves formed on the first side of the first flow path member are arranged perpendicular to lengthwise directions of the grooves formed on the second side of the first flow path member.

11. A production method of a flow path structure, comprising:
forming a catalyst supported on through grooves of a first flow path member;
fitting the first flow path member supporting the catalyst in a second flow path member having a fitting portion, an inflow port and an outflow port to form a flow path along the first flow path member so that the flow path links the inflow port and the outflow port and runs through the through grooves; and
uniting the third flow path member with the second flow path member by welding so that the fitting portion is covered and sealed.

12. The production method of claim 11, wherein the uniting step is accomplished by laser-beam-welding or ultrasonic-welding.

13. The production method of claim 11, wherein a temperature of the catalyst does not reach a sintering temperature where the catalyst is sintered at the uniting step.

14. The production method of claim 11, further comprising joining the second flow path member with the first flow path member at least partly by laser-beam-welding or ultrasonic-welding.

15. The production method of claim 14, wherein a temperature of the catalyst does not reach a sintering temperature where the catalyst is sintered at the joining step.

16. The production method of claim 11, further comprising combining the third flow path member with the first flow path member at least partly by laser-beam-welding or ultrasonic-welding.

17. The production method of claim 16, wherein a temperature of the catalyst does not reach a sintering temperature where the catalyst is sintered at the combining step.

18. A fuel cell system comprising:
a first flow path member having a plurality of through grooves, the through grooves being disposed adjacent to each other;
a second flow path member having a fitting portion, in the fitting portion the first flow path member being fitted;
a third flow path member to seal the fitting portion, the third flow path member being provided on the second flow path member;
an inflow port to receive a fluid;
an outflow port to exhaust an exhaust fluid;
a flow path formed in the fitting portion along the first flow path member, the flow path linking the inflow port and the outflow port and running through the through grooves;
a fuel supplier supplying a fuel to the through grooves;
a catalyst reforming the fuel into a gas including hydrogen, the catalyst being supported on the through grooves; and
a fuel cell using the gas to generate electricity.
